(19) United States
(12) Patent Application Publication
(10) Pub. No.: US 2018/0225395 A1
(43) Pub. Date: Aug. 9, 2018

(54) System and method for designing decks

(71) Applicant: Eric Stalemark, Alpharetta, GA (US)

(72) Inventor: Eric Stalemark, Alpharetta, GA (US)

(21) Appl. No.: 15/428,872

(22) Filed: Feb. 9, 2017

(51) Int. Cl. G06F 17/50

(52) U.S. Cl. CPC G06F 17/5004

(57) ABSTRACT

A method includes receiving a first input identifying a first component of a deck plan, displaying the first component on a screen forming an initial interim deck plan, receiving a second input identifying a second component of a deck plan, placing the second component in a desired location relative to the first component wherein the second component is visible on the screen during the placing step forming an updated interim deck plan, wherein the interim deck plan comprises a double board along a perimeter or partial perimeter of the deck plan and a plurality of posts, each post positioned along the perimeter or partial perimeter of the deck plan equidistant from each other.

### TECHNICAL FIELD

Embodiments of the present inventions relate to methods and systems for designing decks, and more particularly, to a deck design system that provides the designer with code compliant deck designs.

### BACKGROUND

If a person wanted to build a deck, be it attached to a house or free standing, plans would need to be drafted that captured the desired look and functionality. Additionally, each state or local municipality building codes which must be followed which may cause the original designs to be modified to conform to such codes. This can be a time consuming process but one in which a customized deck may be successfully designed.

There are other options, including deck design books which offer standardized deck plans. Additionally, websites such as Lowes.com provide a user the ability to specify particular deck features, including shape, size, height off the ground, railings, stairs and the like. Once the user enters the information, deck designs may be created off-line which can then be retrieved and printed. However, this process could be repetitive and incredibly inefficient due to the off-line nature of the designing algorithm.

As such, there exists a need for a deck design system and method that is real time, that allows a user design flexibility that meets all code requirements and that is fundamentally sound in its recommended construction techniques.

### SUMMARY

The disclosure includes a method including receiving a first input identifying a first component of a deck plan, displaying the first component on a screen forming an initial interim deck plan, receiving a second input identifying a second component of a deck plan, placing the second component in a desired location relative to the first component wherein the second component is visible on the screen during the placing step forming an updated interim deck plan and wherein the interim deck plan comprises a double board along a perimeter of the deck plan and a plurality of posts, each post positioned along the perimeter of the deck plan equidistant from each other.

In an aspect, the method may include receiving a first input identifying a first component of a deck plan, generating structural design elements responsive to the first input, displaying the first component on a screen forming an initial interim deck plan, receiving a second input identifying a second component of a deck plan, updating the structural design elements responsive to the second input and placing the second component in a desired location relative to the first component wherein the second component is visible on the screen during the placing step, thereby forming an updated interim deck plan wherein the updated interim deck plan includes aesthetic design components and structural design components. The structural design components may include a beam along a perimeter of the deck plan and may also include a plurality of posts, each post positioned equidistant along the perimeter of the deck plan and including a post positioned at each change of direction of the perimeter and supporting the beams.

The disclosure is also directed to a system including a display, an input/output system for communicatively coupling the display to an input device and a storage source, a processor communicatively coupled to the input/output system, and memory storing instructions that cause the processor to effectuate operations, the operations including receiving a first input identifying a first component of a deck plan, displaying the first component on a screen forming an initial interim deck plan, receiving a second input identifying a second component of a deck plan, placing the second component in a desired location relative to the first component wherein the second component is visible on the screen during the placing step, forming an updated interim deck plan wherein the interim deck plan comprises a double board along a perimeter of the deck plan and a plurality of posts, each post positioned along the perimeter of the deck plan equidistant from each other and at each change of direction of the perimeter.

### BRIEF DESCRIPTION OF THE DRAWINGS

The following detailed description of preferred embodiments is better understood when read in conjunction with the appended drawings. For the purposes of illustration, there is shown in the drawings exemplary embodiments; however, the subject matter is not limited to the specific elements and instrumentalities disclosed. In the drawings:

FIG. 1 is a schematic representation of an exemplary system environment in which the methods and systems of the present disclosure may be implemented.

FIG. 2 is a top view of an interim deck design created in accordance with the present disclosure;

FIG. 3 is a top view of an alternative interim deck design created in accordance with the present disclosure;

FIG. 4 is a perspective view of an interim deck design created in accordance with the present disclosure;

FIG. 5a is a top view of an exemplary deck plan with the decking removed to illustrate the joists, beams, and posts;

FIG. 5b is a top view of an exemplary deck plan with the decking removed to illustrate the joists, beams, and posts;

FIG. 6 is an exemplary process flow that may be implemented in accordance with the present disclosure.

### DETAILED DESCRIPTION OF ILLUSTRATIVE EMBODIMENTS

Overview. The present disclosure may include systems and methods for a deck design system. The disclosure may include design tools that include building blocks comprising various deck components, including but not limited to the shape and size of deck surfaces, stairs, framing, and the like, all designed in accordance with local building codes. Moreover, the system includes unique features including double sided perimeter boards, support posts positioned on each corner of the deck surface or, in the case of non-rectangular decks, which may, for example, be an octagon or pentagon or any other shape, at the point at which there are any change of the direction of the perimeter of the deck surface.

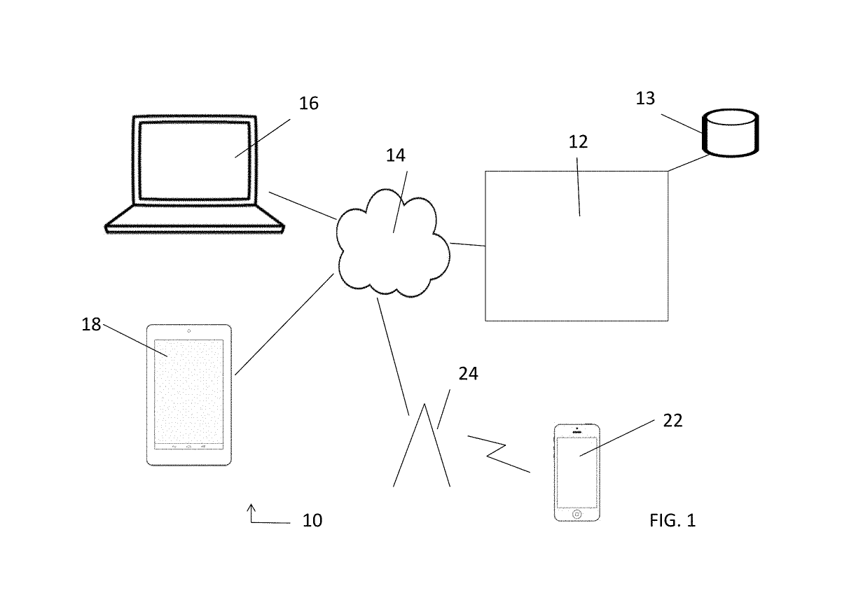

System Environment. With reference to FIG. 1, there is shown an exemplary system 10 configured in accordance with the present disclosure. The system 10 may include a server 12 having computer programs contained therein. The server 12 may be connected to a network 14 which may, for example, be the Internet or any other type of network, including but not limited to a local area network, wide area network, metro area network, and could also be a wireless network, including, but not limited to a 4G LTE or 5G network. It will be understood that the any network type having communication interfaces with the server 12 may be used within the scope of the present disclosure.

In communication with the server 12 through the network 14 may be a personal computer 16 which may be any type of personal computer 16 capable of interfacing with the network 14. The personal computer 16 may have a browser operating thereon. Such browser may include Internet Explorer, Safari, Google Chrome, Firefox, or any other type of network browser. Such browser may, for example, support HTML, HTML5 or any other type of browser interface program capable of interacting with programs running on server 12. While the present disclosure will be described with respect to an HTML5 compatible browser on a personal computer 16 as a client, it will be understood that other user devices such as a tablet 18 and a smartphone 22 connected through cellular system 24 may be used to run client software programs created in accordance with the present disclosure as well.

The server 12 may host computer programs designed to run in a server-client relationship in which personal computer 16 accesses the computer program through a browser. The server may interact with a database 13 which stores data relevant to the design of decks, including, but not limited to, local building codes, building materials, previously designed decks, user profiles and preferences, and any other type of data. Alternatively, data can be accessed by the server 12 across the network 14 from other servers or computer systems connected to the network 14.

In operation, a user may provide inputs through personal computer 16 or other input devices. Such inputs may, for example, include providing login credentials to access the server and data associated with the user. Location information may be retrieved to ascertain local building codes. Previously stored user data including stored deck plans or user preferences in deck plans may be accessed.

Once a user has been successfully connected to the server, the browser may generate a graphical user interface (GUI) for the user to control the use of the program. The GUI may include icons for selecting deck components, including decking sizes and shapes, railings, stairs, layers, and other user selected design choices. The GUI may also show interim designs in real time or quasi real time as more components are added or moved from location to location. The GUI may also include the ability to display multiple views, for example, top plan views, side views and perspective views of the interim designs. In this way, a user may be able to adjust the design iteratively as it is being developed with the focus on the aesthetic design elements and not the details of the construction techniques.

Design Criteria. In accordance with the present disclosure, there are certain design criteria that may be included in the deck designs. On the aesthetic side, a user may specify a shape for the deck, including rectangular, square, octagon, or any other type of shape. Additional design elements may be available, including notches and angles which may affect the shape of the perimeter of the deck and be visible in a top view of the deck. The ability to create two or more levels of decking surface may be provided, including the relative elevation of the decking levels and the connections there between.

The GUI may allow for the selection and placement of stairs, including design elements such as landings or straight stairs. The GUI may allow for a drag and drop scheme wherein the design components are placed relative to the overall deck design. The GUI may allow for the adjustment of sizes based on click and drag resizing schemes.

Additionally, a user may opt to store and subsequently recall design preferences with respect to shapes, styles, and the like as the starting point for other designs. These may be stored in the database 13 connected to server 12 and accessible from the personal computer 16.

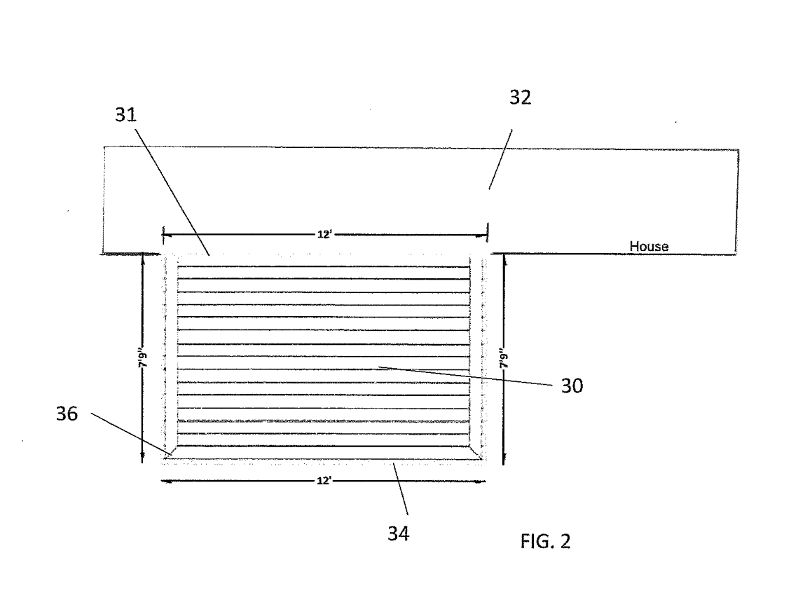

With respect to FIG. 2, there is shown an interim deck 30 design which may be displayed after receiving an input from a user. The deck 30 may be attached to house 32 using techniques known by those skilled in the art, including ledger board 31. The deck 30 may alternatively be freestanding away from any house 32 or other permanent structure. The deck 30 may include sides 34 and having corner 36. While this is shown in rectangular form, it will be understood that other shapes and dimensions may be used in accordance with the present disclosure.

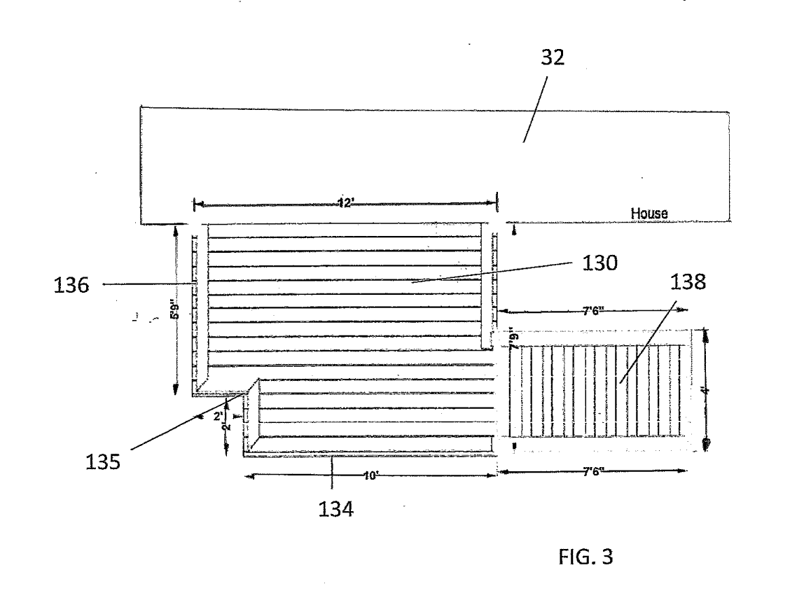

With respect to FIG. 3, there is shown a modification of FIG. 2 in which stairs 138 have been added. Additionally, corner 36 has been replaced with a notch 136 which forms two external 90 degree angles and a complementary 90 degree internal angle. There is also shown sides 134 and railing 136.

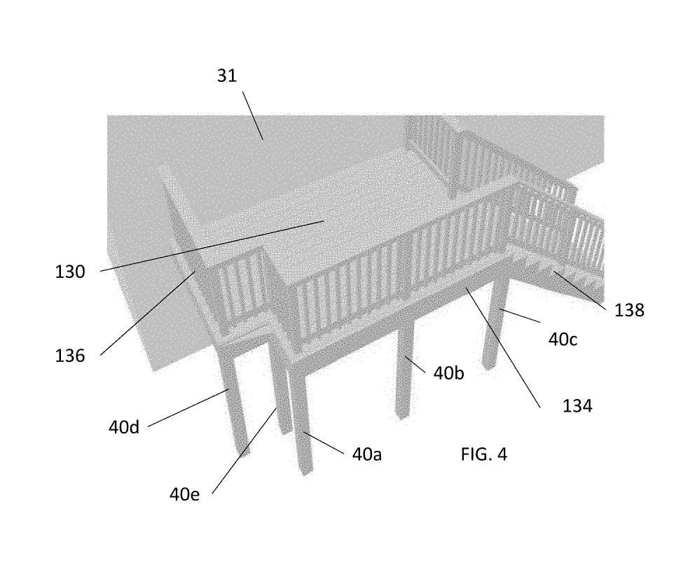

Continuing with reference to FIG. 4, there is shown a perspective view of the deck 130 shown in FIG. 3. From this view, posts 40a, 40b, 40c, 40d and 40e are shown along the perimeter of deck 130. These posts will be collectively described as posts 40 unless the context otherwise indicates.

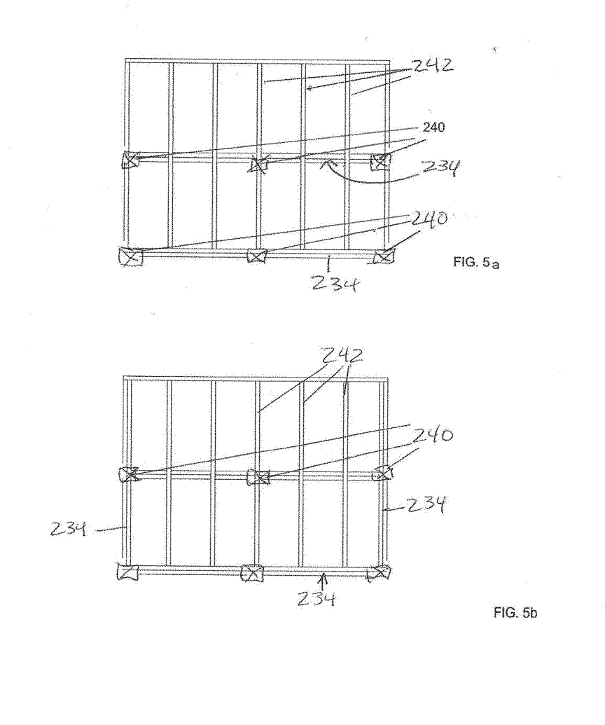

With reference to FIG. 5a, there is shown one embodiment of a deck outline having beams 234 which show a double wide board in the center and edge of the deck outline. Also shown are posts 240 on which the beams 234 are supported. For illustrative purposes, also shown are joists 242 spanning the width of the deck outline which are supported by the beams 234.

FIG. 5b shows an alternative embodiment of the deck outline of FIG. 5a in which three sides of the deck outline (except the side adjacent to the house (not shown) are beams 234 supported by posts 240.

Structural Design Description. Independent of but in support of the aesthetic design elements created through the use of the GUI, the present disclosure may provide structural design elements. For example, the deck design may need to comply with local building codes. Such building codes may, for example, be retrieved from database 13 or from another computer system connected to the network 14, and may include structural design considerations such as the height of railings, the spacing of joists, the spacing of support posts, and the like.

By inputting design the aesthetic design criteria including the location of and attachment to a house 31 and the height above ground level, structural design requirements may be generated without further input from the user. For example, the number of stairs and the rise/run ratio of such stairs may be calculated based on user inputs with reference to the location of the stairs as specified by the user.

The deck does not necessarily need to be square with the connecting house. The system's structural design requirements may include showing a 3-4-5 triangle (in a distinguishing color footing drawing) method of creating a 90-degree line to the house. This may assist with laying out footings.

Additionally, there may be additional structural design criteria that are consistent with building codes, but not necessarily required by such building codes. For example, structural design considerations including, but not limited to the placement of support posts 40 placed equidistant along the perimeter of the deck 130. Such posts 40 may, for example, be placed at the corners of each deck 130 plan and each portion of the deck 130 plan in which a change in direction of the perimeter occurs. For the purposes of this disclosure, a change in direction means that the perimeter of the deck 130 deviates from a substantially straight line and forms angles from 1 degree to 179 degrees. Such change in direction may, for example, occur at the points where two sides connect of a pentagon or octagon shape or points where an angle intersects with a straight edge. By way of further example, if a 90 degree corner is modified to include a notch 135, the support posts 40 based on change in direction may increase from one support post to three. Notwithstanding the posts 40 at each change of direction, posts such as post 240 may be included as support structures in other areas not located on the perimeter of the deck 130. These posts 240 may be positioned in accordance with building codes or other structural considerations.

Additionally, if there are multiple levels to be incorporated into the deck plans, each level may be treated as if it is standalone in terms of structure. For example, a top level of a deck may have a perimeter generally rectangular in shape and a lower level of a deck may have a different shape, such as a hexagon shaped perimeter. Each of these levels may then have structural design components that are consistent with each being independent. The top level may have a perimeter of double-wide side boards supported by equidistant posts along the entire perimeter and at each corner. The lower level may also have a perimeter of double-wide side boards supported by equidistant posts along the entire perimeter and at each change of direction along the perimeter. Steps between the two levels may then be added in accordance with aesthetic and/or structural considerations.

Another structural design criteria which may be included is to place all joists 242 in position on top of the beams 234 supported by posts 240. The beams 234 may be placed along the perimeter or within the area of the deck if desired for additional support.

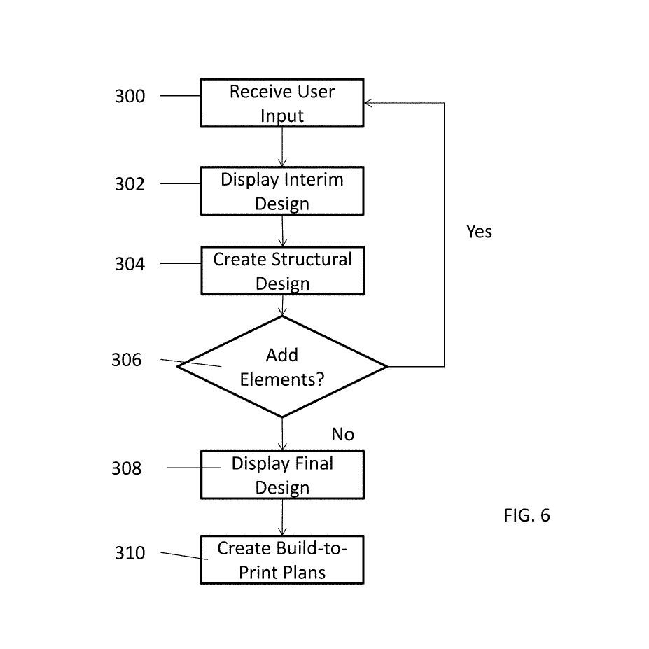

Process Description. With reference to FIG. 6, there is shown an exemplary process flow which may be implemented in accordance with the present disclosure. At 300, user input is received. Such user input may be in the form of a selection on a GUI either by a click or click and drag methodology or any other type of user input, including text inputs directly or through the use of drop down menus. At 302, an interim deck design is displayed. At 304, structural design components are adjusted. These include, but are not limited to, compliance with building codes, posts on each corner or change of direction along the perimeter, double-board sides, and beams resting upon posts and any other structural design components to be included in the deck design. At 306, the decision is made as to whether additional design elements need to be added. Such design elements may include stairs, angles, notches, railings, second or more levels of deck, and any other aesthetic or functional design elements. If the answer is yes, then the process repeats at 300. At 308, if no additional design elements are to be added, the final design is displayed and build-to-print plans are generated at 310.

The system created in accordance with the present disclosure may create plans that are ¼″=1′ scale on larger paper such as 11″×17″ or even larger paper to accommodate larger decks to ¼″=1′ scale. This size paper will allow for larger decks to be displayed in this ¼″=1′ scale (quarter inch equals one foot scale).

Although not every conceivable combination of components and methodologies for the purposes describing the present disclosure have been set out above, the examples provided will be sufficient to enable one of ordinary skill in the art to recognize the many combinations and permutations possible in respect of the present disclosure. Accordingly, this disclosure is intended to embrace all such alterations, modifications and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

While example embodiments have been described in connection with various computing devices/processors, the underlying concepts can be applied to any computing device, processor, or system capable of implementing the present disclosure as described herein. The methods and apparatuses, or certain aspects or portions thereof, can take the form of program code (i.e., instructions) embodied in tangible storage media having a physical structure, such as floppy diskettes, CD-ROMs, hard drives, or any other machine-readable storage medium having a physical tangible structure (computer-readable storage medium), wherein, when the program code is loaded into and executed by a machine, such as a computer, the machine becomes an apparatus for distributing connectivity and/or transmission time. A computer-readable storage medium, as described herein is an article of manufacture, and thus, is not to be construed as a transitory signal. In the case of program code execution on programmable computers, which may, for example, include server 12, the computing device will generally include a processor, a storage medium readable by the processor (including volatile and non-volatile memory and/or storage elements), at least one input device, and at least one output device. The program(s) can be implemented in assembly or machine language, if desired. The language can be a compiled or interpreted language, and combined with hardware implementations.

The methods and systems of the present disclosure may be practiced via communications embodied in the form of program code that is transmitted over some transmission medium, such as over electrical wiring or cabling, through fiber optics, wherein, when the program code is received and loaded into and executed by a machine, such as an EPROM, a gate array, a programmable logic device (PLD), a client computer, a controller, or the like, the machine becomes an apparatus for use in reconfiguration of systems constructed in accordance with the present disclosure. When implemented on a general-purpose processor, the program code combines with the processor to provide a unique apparatus that operates to invoke the functionality described herein.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed:

1. A method comprising:
receiving a first input identifying a first component of a deck plan;
displaying the first component on a screen forming an initial interim deck plan;
receiving a second input identifying a second component of a deck plan;
placing the second component in a desired location relative to the first component wherein the second component is visible on the screen during the placing step forming an updated interim deck plan;
wherein the interim deck plan comprises a double board along a perimeter of the deck plan and a plurality of posts, each post positioned along the perimeter of the deck plan equidistant from each other.
